(19) United States
(12) Patent Application Publication
(10) Pub. No.: US 2011/0213879 A1
(43) Pub. Date: Sep. 1, 2011

(54) Multi-level Decision Support in a Content Delivery Network

(76) Inventors: Ashley Edwardo King, Tijeras, NM (US); Steve J. Shattil, Cheyenne, WY (US)

(21) Appl. No.: 13/036,812

(22) Filed: Feb. 28, 2011

Related U.S. Application Data
(60) Provisional application No. 61/308,997, filed on Mar. 1, 2010.

(51) Int. Cl. G06F 15/173

(52) U.S. Cl. 709/224

(57) ABSTRACT

A content delivery network (CDN) is provided with a multi-tiered decision-support system. Client-side metrics managers collect link-performance data from client devices for formulating requests for network resources from the CDN. Network-node metrics managers broker the network resources from the CDN to the clients based on data collected from the client-side metrics managers. A node-cloud metrics manager distributes the network resources between a plurality of network nodes based on data collected from the network-node metrics managers. When the CDN includes a wireless network, formulating the requests and/or brokering the network resources may be adapted based on network performance data corresponding to the wireless network.

### CROSS-REFERENCE TO RELATED APPLICATIONS

This application claims priority under 35 U.S.C. 119(e) to U.S. Provisional Application Ser. No. 61/308,997, filed Mar. 1, 2010.

### BACKGROUND OF THE INVENTION

I. Field of the Invention

The present invention relates to a system and a method for a content delivery network (CDN), and in particular, to systems and methods for managing resources for content distribution.

II. Description of the Related Art

Distributed computer systems are well-known in the prior art. One such distributed computer system is a content delivery network (CDN) that is operated and managed by a service provider. The service provider typically provides the service on behalf of third parties. A distributed system of this type typically refers to a collection of autonomous computers linked by a network or networks, together with the software, systems, protocols and techniques designed to facilitate various services, such as content delivery or the support of out-sourced site infrastructure.

A CDN employs a collection of content servers and associated control mechanisms to offload work from Website origin servers by delivering content on their behalf to end users. A well-managed CDN achieves this goal by serving some or all of the contents of a site's Web pages, thereby reducing the customer's infrastructure costs while enhancing the end-users' browsing experience. In operation, the CDN uses a request routing mechanism to locate a CDN content server close to the client to serve each request directed to the CDN, where the notion of “close” is based, in part, on evaluating results of network traffic tests.

As the volume of Internet traffic grows, providers of web content and applications increasingly need to deliver content from multiple servers at widely-separated locations in order to sustain a good end-user experience under high traffic loads. This need generates several challenges, including, among others, how to guarantee the fault-tolerance of such a multiple-server system in the face of failure of one or more individual servers; how to control how requests from end-users are distributed to each server; and how to guarantee high performance for end-users as network conditions change.

### SUMMARY OF THE INVENTION

The present invention solves these and other problems by collecting data on network functionality at multiple levels and using the data to control network access and/or network configurations at multiple levels. The data can range from an extremely fine-grained level of network functionality, such as network access at the client level, to a macroscopic view of network functionality, such as the distribution of network resources to groups of edge servers. This data is used to control and configure network access on multiple levels, such as adapting network access for individual clients at a local level, to managing network services provided by edge servers and parent servers.

This multi-level, or tiered approach to collecting and analyzing network data, and then performing decision support for distributing network resources enables providers of Internet content and applications to dramatically improve the end-user experience measured by speed of request resolution, associated download time, and the availability of servers.

One aspect of the invention is directed towards methods, systems, and computer-readable media comprising program code for performing multi-level decision support in a CDN. A plurality of client-side metrics managers are configured for collecting client-side data. The client-side metrics managers are operable for managing interactions between individual clients and the network, which may include, by way of example, but without limitation, selecting media streams based on the available bandwidth at each client.

In the case where one or more client devices are served by a wireless network, the client-side metrics managers may adapt the interactions between the clients and the network based on network performance data corresponding to the wireless network.

A plurality of network-node metrics managers may be configured for collecting data from multiple client-side metrics managers and brokering network services (or distributing network services) to the clients.

In the case where one or more client devices are served by a wireless network, the network-node metrics managers may adapt the brokering and/or distribution of network services to the clients based on network performance data corresponding to the wireless network.

A node-cloud metrics manager may be configured for collecting data from multiple network-node metrics managers and distributing network services between network nodes, which may include communicatively coupling edge servers to parent servers and/or managing the assignment of clients to edge servers.

According to another aspect of the invention, a CDN comprises a content-delivery infrastructure, a request-routing mechanism, and a distribution mechanism. The content-delivery infrastructure is a network of geographically-distributed content delivery nodes that are arranged for efficient delivery of content on behalf of third party content providers. The content delivery infrastructure usually comprises a set of “surrogate” origin servers (e.g., edge servers) that are located at strategic locations (e.g., Internet network access points, Internet Points of Presence, and the like) for delivering content to requesting end users. The request-routing mechanism allocates servers in the content delivery infrastructure to requesting clients in a way that, for web content delivery, minimizes a given client's response time and, for streaming media delivery, provides for the highest quality. The distribution mechanism includes on-demand or push-based mechanisms that move content from the origin server to the surrogates. The request-routing mechanism and the distribution mechanism include methods, systems, and computer-readable media comprising program code for managing hierarchical data collection, analysis, and decision support for efficiently distributing network resources to a plurality of clients.

In the case where one or more client devices are served by a wireless network, at least one of the request-routing mechanism and the distribution mechanism may adapt the brokering and/or distribution of network services to the clients based on network performance data corresponding to the wireless network.

In accordance with one aspect of the invention, a hierarchical computing system for managing the distribution of content in a CDN comprises a device field, a client field, and a digi-node field. The device field is configured for managing interactions between multiple client-side components with a network node. The client field couples multiple device fields together for distributing network services to multiple clients. The digi-node field couples multiple client fields together for distributing network services to multiple nodes.

### BRIEF DESCRIPTION OF THE DRAWINGS

The invention is illustrated in the figures of the accompanying drawings which are meant to be exemplary and not limiting, in which like references are intended to refer to like or corresponding parts, and wherein:

FIG. 1 is a block diagram of CDN employing a hierarchical computing system according to one aspect of the invention;

FIG. 2 is a block diagram of a CDN in accordance with one aspect of the invention;

FIG. 3 is a block diagram of a client device configured in accordance with an aspect of the invention;

FIG. 4 is a flow diagram illustrating a method for managing a client's interactions with a network configured in accordance with one aspect of the invention; and

FIG. 5 is a flow diagram illustrating the function of a multi-level decision support system implemented in a CDN according to an aspect of the present invention.

### DETAILED DESCRIPTION

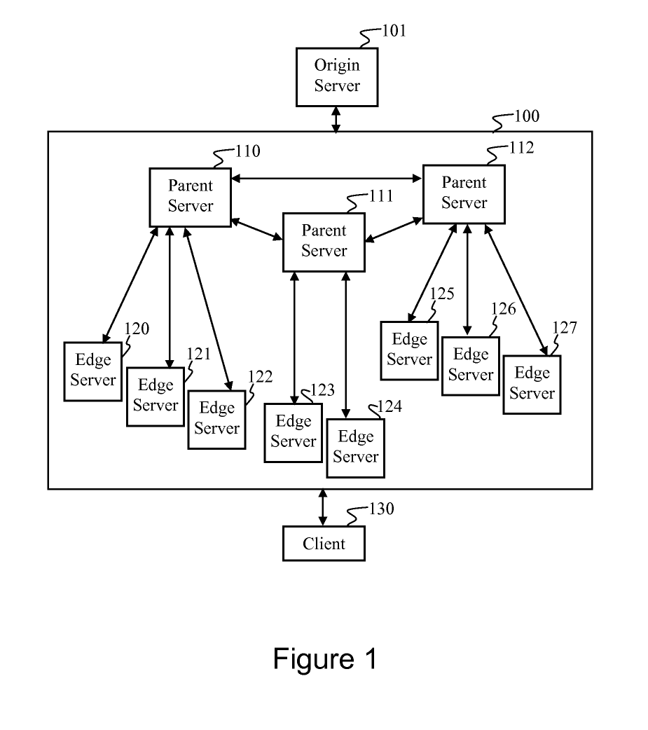

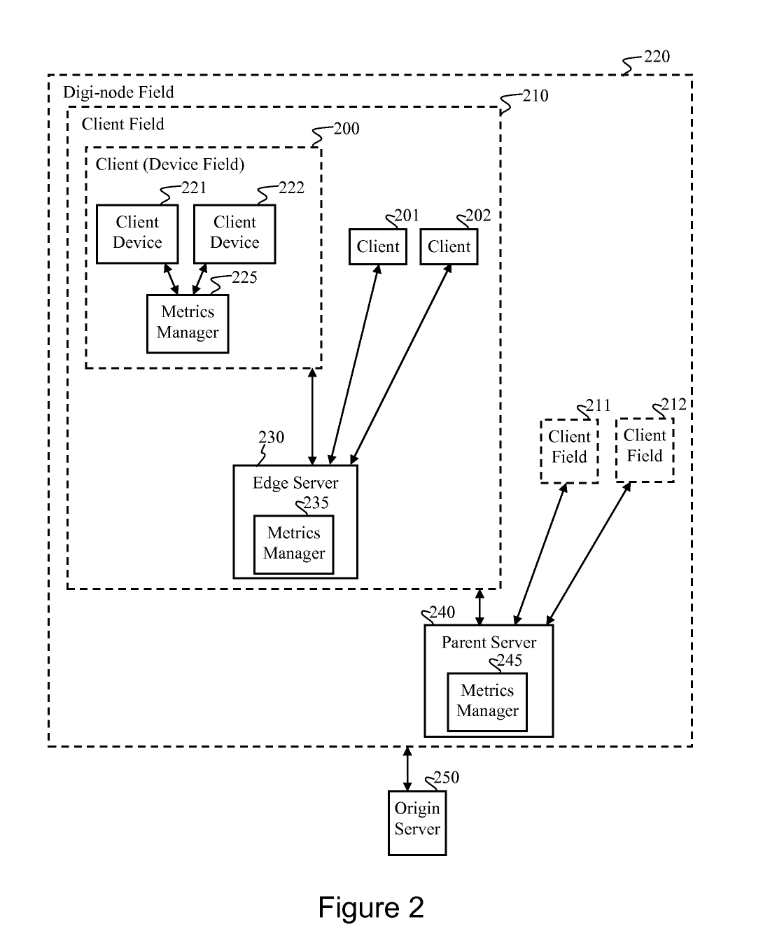

The subject matter described herein may be implemented in a CDN, such as illustrated in FIGS. 1 and 2. Use in a CDN is a not a limitation, however, as the subject matter may be implemented in any environment in which one entity operates a distributed network from which third party content may be distributed.

In the following description, reference is made to the accompanying drawings that form a part hereof, and in which is shown by way of illustration specific aspects in which the invention may be practiced. It is to be understood that other aspects and embodiments may be utilized, and structural changes may be made without departing from the scope of the present invention.

A CDN according to aspects of the invention is illustrated in FIG. 1. The network 100 comprises one or more parent server sites 110-112 and one or more edge server sites 120-127. The network 100 also optionally has access to one or more origin server sites 101. The origin server sites 101 are typically owned and/or maintained by the network provider's customers for storing and serving one or more objects. Content provider companies, organizations, etc. that subscribe to the CDN service are referred to as customers. Each customer (i.e., content provider) may have its own origin server site. Furthermore, one or more clients, such as client 130, access the network 100 to request one or more objects.

As used herein, an object includes, without limitation, an audio file (such as, e.g., an MP3 (Motion Picture Experts Group-1 Layer 3) file and a RealNetworks, Inc. Real format file), a video file (such as an MPEG file), an image file (such as, e.g., a BMP (bitmap) file or JPEG (Joint Photographic Experts) file) and any other software or data file or object.

A parent server site (or simply parent site or parent server) may comprise one parent server or a cluster of parent servers. Likewise, an edge server site (or simply an edge site or edge server) may comprise one edge server or a cluster of edge servers, and an origin server site (or simply an origin site or origin server) may comprise one origin server or a cluster of origin servers. The network 100 may be configured such that servers in a cluster share a common storage. However, aspects of the invention may use a variety of different network configurations.

In a typical CDN, the parent servers 110-112 and edge servers 120-127 are maintained by a network provider, wherein the parent servers 110-112 are primarily used for storing and managing one or more objects, and edge servers 120-127 are primarily used for serving the objects to clients 130. End-users or client proxies that access customers' objects are referred to as clients.

In some aspects of the invention, all the objects are retrieved from origin servers 101 and stored on one or more parent servers 110-112 before the client 130 can access each such object. Accordingly, in these aspects, the origin servers 101 play no significant role in object replication and delivery except to supply new and/or updated objects for storage on the parent servers 110-112. Moreover, only the parent servers 110-112 communicate with the origin servers 101. In other aspects, each requested object is replicated from one or more origin servers 101 to one or more parent servers 110-112 (and/or one or more edge servers 120-127) when the requested object becomes popular. In these aspects, the origin servers 101 play a more significant role in object replication and delivery to supply objects to parent servers 110-112 and/or edge servers 120-127 when requested. So, in these aspects, the origin servers 101 and parent servers 110-112 communicate with each other, and the origin servers 110-112 and clients 130 may also communicate with each other. In all of these aspects, the communications relationships between origin servers 101 and parent servers 110-112 may be one-to-one, one-to-many, or many-to-many.

As shown in FIG. 1, the parent servers 110-112 and edge servers 120-127 communicate with each other, and the edge servers 120-127 and clients 130 communicate with each other. Furthermore, the parent servers 110-112 and clients 130 may communicate with each other. In aspects of the invention illustrated in FIG. 1, the edge servers 120-127 have a one-to-one or one-to-many communications relationship with the parent servers 110-112, and the edge servers 120-127 may also have many-to-many communications relationships with parent servers 110-112. Typically, the edge servers 120-127 act as the primary source for serving objects. However, if a requested object is not available at the edge server 120-127, a parent server 110-112 may serve the requested object to the clients. Also, FIG. 1 shows a single layer or level of parent servers 110-112 and a single layer or level of origin servers 101. As will be apparent to those skilled in the art, more than one layer or level of parent servers 110-112 and/or origin servers 101 may be employed.

An edge server 120-127 is selected to serve content to the client 130 based, at least in part, on load conditions on at least some of the edge servers 120-127 and on the client's 130 location. Load balancing takes into account the load at each edge server 120-127 (which can be measured in a variety of ways) to select which edge server 120-127 should handle a particular request. Other techniques take other factors into account, such as network performance and topology, in making the determination.

FIG. 2 is a block diagram of a CDN in accordance with one aspect of the invention. A client 200 comprises a device field, which may include one or more client devices, such as client devices 221 and 222 communicatively coupled to a client-side metrics manager 225. The metrics manager 225 may reside on one or more of the client devices 221 and 222. The metrics manager 225 collects data from the client devices 221 and 222 and manages client interactions with the CDN. Specifically, the metrics manager 225 employs the collected data to formulate requests for network resources (e.g., media services) from the CDN. In one aspect of the invention, at least one of the client devices is served by a wireless link, and the metrics manager 225 is configured to manage client interactions with the network based on wireless network performance data. For example, the metrics manager 225 may request a media stream bandwidth from the CDN based on the quality of a communications link serving at least one of the client devices 200-202. The link quality may be indicated by the wireless network performance data. The link quality may be indicated by other factors, such as the amount of data stored in a client device's buffer, or a low-bandwidth status warning from a device in response to detected pixilation or frame slowing of media presented in the client's display. The metrics manager 225 may be responsive to status and/or warning indicators generated by the client devices 200-202 for adapting (e.g., formulating) the requests for the media resources.

An edge server 230 serves one or more clients, such as clients 200-202. Clients 201 and 202 each comprise one or more client devices (not shown) and a client-side metrics manager (not shown). The edge server 230 comprises a network node metrics manager 235 configured for collecting data from one or more client-side metrics managers (e.g., metrics manager 225) and brokering network resources from the CDN to the clients 200-202. The edge server 230 and the clients 200-202 it serves are part of a client field 210. The client field 210 is managed by the metrics manager 235 for distributing network resources (e.g., media services) to the clients 200-202.

The data employed by the metrics manager 235 may comprise raw and/or processed client-side data. For example, the data may comprise a number of requests for media resources, types of media resources requested, and/or bandwidths of the requested media resources. The data may comprise aggregations of the client-side data, such as the total bandwidth requested. The data may comprise indications of changing network loads (e.g., the number of requests for increased/decreased bandwidth) and/or changes in network performance (e.g., number of acknowledgements, number of requests for retransmission, measured latency, packet error rate, etc.). The metrics manager 235 allocates the network resources from the CDN to the clients 200-202 based, at least in part, on the data collected from the client-side metrics managers 225.

In one aspect of the invention, at least one of the client devices is served by a wireless link, and the network node metrics manager 235 is configured to distribute the network services from the CDN to the client devices based on wireless network performance data.

According to one aspect of the invention, the network node metrics manager 235 receives a request from one of the clients 200-202 in the client field 210. The metrics manager 235 may perform a check to determine if a cached copy of the requested object is available at the edge server 230. Where a cached copy of the requested object is available to the edge server 230 (e.g., in a data store coupled to the edge sever), the edge server 230 transmits the cached copy of the object to the client. The method may further comprise transmitting the request to a parent server or an origin server if the cached copy is not available at the edge server 230. Alternatively, the metrics manager 235 (or node cloud metrics manager 245) may reassign the client field 210 to a different edge server.

A parent server 240 comprising a node cloud metrics manager 245 is communicatively coupled to a plurality of client fields, such as client fields 210-212. The metrics manager 245 is configured for collecting data from multiple network node metrics managers, such as network node metrics manager 235, for distributing network services between edge servers 230. The parent server 240 and the client fields 210-212 it serves is denoted as a digi-node field 220. The digi-node field 220 is managed by the metrics manager 245 for distributing network services to the edge servers, such as edge server 230.

The data employed by the metrics manager 245 may comprise raw and/or processed data from the network node metrics managers (such as metrics manager 235). The data may comprise a number of requests for media resources, types of media resources requested, and/or bandwidths of the requested media resources. The data may comprise aggregations of the client-side data and/or data from the network node metrics managers. For example, the data may comprise the total bandwidth requested, or the amount of bandwidth requested at each edge server. The data may comprise indications of changing network loads (e.g., the number of requests for increased/decreased bandwidth) and/or changes in network performance (e.g., number of acknowledgements, number of requests for retransmission, measured latency, packet error rate, etc.). The metrics manager 235 distributes the network resources of the CDN between the network nodes (e.g., edge servers) based, at least in part, on the data collected from the metrics managers 235.

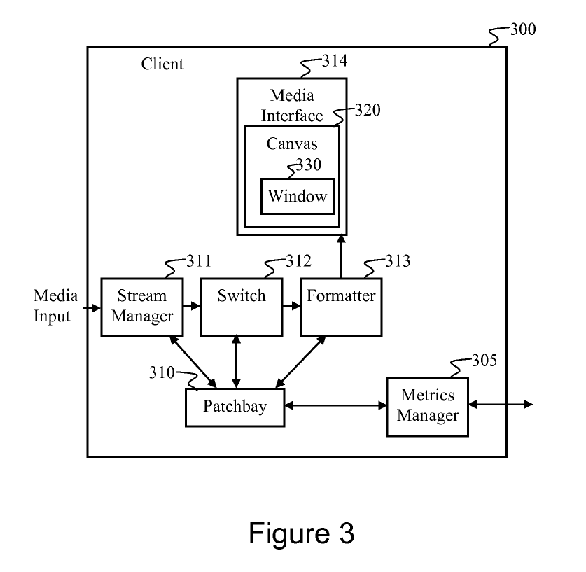

FIG. 3 is a block diagram of a client device 300 configured in accordance with an aspect of the invention. A client-side metrics manager 305 is communicatively coupled to functional blocks 311-313 by a patchbay 310. It will be appreciated that the metrics manager 305, functional blocks 311-313, and patchbay 310 may comprise any combination of hardware and software.

The functional blocks 311-313 comprise a stream manager 311, a switch 312, and a formatter 313. The stream manager 311 receives media input and meta-data about each available media stream matching a predetermined criterion. The switch 312 selects at least one of the streams based on stream bandwidth and the quality of service that the communication link can support. The formatter 313 is coupled to a media interface 314 of the client device 300. The formatter 313 may be communicatively coupled to a second media interface (not shown) of a second client device (not shown), such as via the metrics manager 305. The media interface 314 comprises a canvas 320 display in which one or more windows 330 may be employed for presenting (e.g., displaying) the media stream. The formatter 313 formats the media stream relative to the client device on which the stream is presented. For example, the formatter 313 may adapt the video portion of the stream relative to characteristics of the window 330 in which the stream is displayed.

In one aspect of the invention, at least one of the client devices is served by a wireless link, and the switch 312 is configured to select at least one of the available media streams based on wireless network performance data.

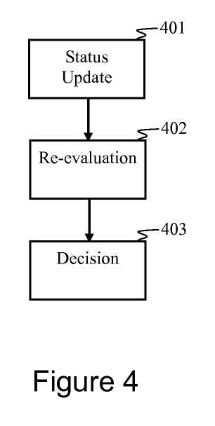

FIG. 4 is a flow chart illustrating a method for managing a client's interactions with a network configured in accordance with one aspect of the invention. In a status-update step 401, the window 330 sends a message to the metrics manager 305 indicating a low-bandwidth problem. For example, low bandwidth may be indicated by pixilation or interrupted video. In a re-evaluation step 402, the metrics manager 305 is responsive to the status update and instructs the switch 312 to re-evaluate the average bandwidth of the link. The switch 312 calculates the average bandwidth over a predetermined time interval and compares the resulting bandwidth value to the bandwidth of the available streams indicated by the stream manager 311. In a decision step 403, the switch selects a new stream having a bandwidth that more closely matches the average bandwidth of the link. The metrics manager 305 may also be responsive to user-generated events, such as when a user selects one of a plurality of user devices, and the selection changes the bandwidth requirements of the stream that can be received. The metrics manager 305 may be responsive to network performance data for a wireless network serving the client device.

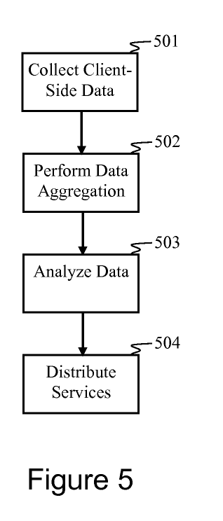

FIG. 5 is a flow diagram illustrating the function of a multi-level decision support system implemented in a CDN. Each of a plurality of client-side metrics managers collects client-side data 501 pertaining to client interactions with the network. For example, the metrics manager 225 may collect client-side data regarding the average stream bandwidth, changes to the average stream bandwidth, low-bandwidth indications, and stream selection. Client-side data may comprise other client interactions with the network as well. The metrics manager 225 manages the client interactions with the network based on client-specific events. In one aspect of the invention, the metrics manager 225 manages the client interactions with the network based on network performance data for at least one wireless network serving the client.

The metrics manager 225 communicates its client-side data to the network node metrics manager 235 of its edge server 230. The metrics manager 235 receives client-side data from a plurality of client-side metrics managers in a data-aggregation step 502, analyzes the data 503, and distributes network services accordingly 504. For example, the metrics manager 235 may allocate more network bandwidth to a client that reports a large number of low-bandwidth indications. The metrics manager 235 collects network node data about its interactions with its clients, including its ability to serve the clients. The metrics manager 235 may also process the client-side data and include it as part of the network node data.

The metrics manager 235 communicates its network node data to the node cloud metrics manager 245. The metrics manager 235 receives network node data from a plurality of network node metrics managers and distributes network services between the edge servers accordingly. Furthermore, the node cloud metrics manager 245 may reassign clients to different edge servers based on the network node data.

Although the flow diagrams may describe operations as a sequential process, many of the operations can be performed in parallel or concurrently. In addition, the order of the operations may be re-arranged. A process is terminated when its operations are completed, but could have additional steps not included in the figures. A process may correspond to a method, a function, a procedure, a subroutine, a subprogram, etc. When a process corresponds to a function, its termination corresponds to a return of the function to the calling function or the main function.

The Figures are conceptual illustrations allowing for an explanation of the present invention. It should be understood that various aspects of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant arts.

1. A multi-tiered decision-support system, comprising:
a plurality of client-side metrics managers configured for collecting client-side data for formulating requests for network resources from a content delivery network (CDN);
a plurality of network-node metrics managers configured for collecting data from the client-side metrics managers and brokering the network resources from the CDN to the clients; and
a node-cloud metrics manager configured for collecting data from the network-node metrics managers and distributing the network resources between a plurality of network nodes.

2. The system recited in claim 1, wherein the node-cloud metrics manager is configured for communicatively coupling edge servers to parent servers and assigning the clients to the edge servers.

3. The system recited in claim 1, wherein the client-side data comprises at least one of average stream bandwidth, changes to the average stream bandwidth, low-bandwidth indications, and stream selection.

4. The system recited in claim 1, wherein the data from the network-node metrics managers comprises the client-side data.

5. The system recited in claim 1, wherein at least one of the clients is served by a wireless network and the plurality of client-side metrics managers is configured to adapt the requests based on network performance data corresponding to the wireless network.

6. The system recited in claim 1, wherein at least one of the clients is served by a wireless network and the plurality of network-node metrics managers is configured to adapt the brokering based on network performance data corresponding to the wireless network.

7. The system recited in claim 1, wherein at least one of the plurality of client-side metrics managers resides on a plurality of client devices.

8. The system recited in claim 1, wherein each of the plurality of client-side metrics managers comprises a stream manager, a switch, and a formatter.

9. A computer-implemented method, comprising:
processing client-side data for formulating requests for network resources from a content delivery network (CDN);
processing data from a plurality of client-side metrics managers for brokering the network resources from the CDN to a plurality of clients; and
processing data from a plurality of network-node metrics managers for distributing the network resources between a plurality of network nodes.

10. The method recited in claim 9, wherein distributing the network resources comprises communicatively coupling edge servers to parent servers and assigning the plurality of clients to edge servers.

11. The method recited in claim 9, wherein the client-side data comprises at least one of average stream bandwidth, changes to the average stream bandwidth, low-bandwidth indications, and stream selection.

12. The method recited in claim 9, wherein the data from the plurality of network-node metrics managers comprises the client-side data.

13. The method recited in claim 9, wherein at least one of the clients is served by a wireless network, and at least one of formulating the requests, brokering, and distributing is based on network performance data corresponding to the wireless network.

14. The method recited in claim 9, wherein at least one of the client-side metrics managers resides on a plurality of client devices.

15. The method recited in claim 9, wherein formulating requests comprises responding to status updates, calculating average bandwidth of a communication link serving at least one client, and selecting an available media stream based on bandwidth calculations.

16. A computer program residing on one or more computer-readable media, comprising:
a client-side metrics manager source-code segment configured for collecting client-side data for formulating requests for network resources from a content delivery network (CDN);
a network-node metrics manager source-code segment configured for brokering the network resources from the CDN to the clients based on data collected from the client-side metrics manager source-code segment; and
a node-cloud metrics manager source-code segment configured for distributing the network resources between a plurality of network nodes based on data collected from the network-node metrics manager source-code segment.

17. The computer program recited in claim 16, wherein distributing the network resources comprises communicatively coupling edge servers to parent servers and assigning the plurality of clients to edge servers.

18. The computer program recited in claim 16, wherein the client-side data comprises at least one of average stream bandwidth, changes to the average stream bandwidth, low-bandwidth indications, and stream selection.

19. The computer program recited in claim 16, wherein the data from the plurality of network-node metrics managers comprises the client-side data.

20. The computer program recited in claim 16, wherein at least one of the clients is served by a wireless network, and at least one of formulating the requests, brokering, and distributing is based on network performance data corresponding to the wireless network.

21. The computer program recited in claim 16, wherein the client-side metrics manager source-code segment resides on a plurality of client devices.

22. The computer program recited in claim 16, wherein formulating requests comprises responding to status updates, calculating average bandwidth of a communication link serving at least one client, and selecting an available media stream based on bandwidth calculations.
